(19) United States
(12) Patent Application Publication
(10) Pub. No.: US 2009/0053922 A1
(43) Pub. Date: Feb. 26, 2009

(54) Connector for jack

(76) Inventors: Kazuhiro Sato, Tokyo (JP); Hirokazu Takahashi, Tokyo (JP); Yukio Saitou, Tokyo (JP); Kazunori Takei, Tokyo (JP); Hitoshi Kikuchi, Tokyo (JP)

Correspondence Address: DICKSTEIN SHAPIRO LLP, 1825 EYE STREET NW, Washington, DC, 20006-5403, US

(21) Appl. No.: 12/222,524

(22) Filed: Aug. 11, 2008

(30) Foreign Application Priority Data
Aug. 22, 2007 (JP) 2007-215,652

(51) Int. Cl. H01R 13/62

(52) U.S. Cl. 439/296

(57) ABSTRACT

A connector for a jack includes four contacts of first, second, third and fourth contacts each having a contact portion and a connection portion, and a housing, to exchange signals and to ascertain whether a plug connector has been inserted into the connector. The third contact substantially U-shaped in cross-section includes a contact piece having a first contact part adapted to contact the plug connector, and a spring piece having an elasticity facing to the contact piece and provided by forming a U-shaped slit in a part of the third contact at a location opposite to the contact piece. When the plug connector is inserted into the connector, the plug connector pushes the first contact part of the contact piece to cause the contact piece to be displaced to the spring piece so that the contact piece pushes the spring piece to cause the spring piece to be displaced toward the housing and at the same time the spring piece pushes the contact piece with each other with the aid of its elasticity. The connector achieves a reliable holding force for the plug connector without scratching it.

### BACKGROUND OF THE INVENTION

This invention relates to a connector for a jack for use in electric and electronic appliances such as audio appliances, and more particularly to a connector for a jack having a structure enabling a stable holding force to be maintained for a plug connector as a mating connector without scratching or damaging the plug connector.

A hitherto used connector for a jack will be explained with reference to FIGS. 10A to 11B. FIG. 10A is a sectional view of the connector for a jack of the prior art before a plug connector is inserted, and FIG. 10B is a sectional view of the connector for a jack of the prior art with the plug connector inserted. FIG. 11A is a perspective view of a third and a fourth contacts in contact with each other used in the prior art connector viewed from the side of a contact piece of the third contact, while FIG. 11B is a perspective view of the third and fourth contacts in contact with each other viewed from the opposite side of the contact piece of the third contact. The connector 70 for a jack of the prior art comprises a housing 72 and four contacts (first contact 14, second contact 16, third contact 78, and fourth contact 20). The contacts 14, 16, 78 and 20 each comprise at least a contact portion 34 adapted to contact with said plug connector 80 or the other contact, and a connection portion 36 to be connected to a substrate. Said housing 72 is formed with a fitting hole 46 for inserting said plug connector 80. Said first, second and third contacts 14, 16 and 78 are arranged in the housing such that the contact portions 34 of said first and second contacts 14 and 16 and a first contact part 40 of said third contact 78 extend into said fitting hole 46. Said fourth contact 20 is arranged so as to be in contact with said third contact 78 in the state that said plug connector 80 has not been inserted into the connector 70. The first and second contacts 14 and 16 are brought into contact with said plug connector 80 to exchange signals between the connector 70 and the plug connector 80. The third and fourth contacts 78 and 20 serve to ascertain whether the plug connector 80 has been inserted into the connector depending on whether said third and fourth contacts 78 and 20 are in contact with or out of contact with each other.

As examples of connectors for jacks, incorporated herein are Japanese Patent Application Opened No. 2001-217,053 (Patent Literature 1) and Japanese Patent Application Opened No. H10-22,004 (1998) (Patent Literature 2).

Patent Literature 1

According to the abstract of the Japanese Patent Application Opened No. 2001-217,053, this invention has an object to provide a jack for a connector, including a member forming an inserting opening for receiving a connector plug having a tip electrode and a ring electrode and including in the inserting opening a tip-contact piece adapted to abut against the tip electrode and a ring-contact piece adapted to abut against the ring electrode in the state that the connector plug has been inserted into the inserting opening, wherein when the connector plug is being inserted into the inserting opening, on its way thereinto occurrence of noise due to short-circuiting between the ring-contact piece and the tip-contact piece is prevented as much as possible. Disclosed is a jack for a connector constructed in that a distance from a position on a ring-contact piece 4r1 where the ring-contact piece 4r1 abuts against a tip electrode TE to a position on a tip-contact piece 4t where the tip-contact piece 4t starts to abut against the tip electrode TE is in excess of a distance from the distal end to the proximal end of the tip electrode TE in order to perform the operation for inserting the connector plug 100 toward the completion of the insertion via an intermediate state that the ring-contact piece 4r1 is spaced apart from the tip electrode TE and the tip electrode TE is spaced apart from the tip-contact piece 4t.

Incidentally, claim 1 of the Japanese Patent Application Opened No. 2001-217,053 recites a jack for a connector including a jack body formed with a plug inserting opening for receiving a connector plug having a tip electrode and a ring electrode to be inserted along its axis, and further including in said plug inserting opening a tip-contact piece adapted to abut against said tip electrode and a ring-contact piece adapted to abut against said ring electrode in the state that said connector plug has been completely inserted into said plug inserting opening, wherein said ring-contact piece has an abutting portion to abut against the proximal end of said tip electrode during the inserting procedure of said connector plug, and said tip-contact piece has an abutment-starting portion to start abutting against the distal end of said tip electrode during the inserting procedure of said connector plug, and wherein a distance from the abutting portion of said ring-contact piece to said abutment-starting portion of said tip-contact piece along said axis is in excess of a distance from said distal end to said proximal end of said tip electrode. Claim 2 recites a jack for a connector including a jack body formed with a plug inserting opening for receiving a connector plug having a tip electrode and a ring electrode to be inserted along its axis, and further including in said plug inserting opening a tip-contact piece adapted to abut against said tip electrode and a ring-contact piece adapted to abut against said ring electrode in the state that said connector plug has been completely inserted into said plug inserting opening, wherein in inserting said connector plug into said plug inserting opening, the inserting operation proceeds from an initial state that said tip electrode abuts against said ring-contact piece but is spaced from said tip-contact piece, through an intermediate state that said ring-contact piece is spaced apart from said tip electrode which is spaced from said tip-contact piece, to a completely inserted state that said tip electrode abuts against said tip-contact piece and said ring electrode abuts against said ring-contact piece. Claim 3 recites the jack for a connector as claim 1 or 2, wherein said tip electrode has a tapered surface to increase its diameter progressively toward the tip of said connector plug and further comprises regulating means for preventing said connector plug from being removed from said plug inserting opening, said regulating means comprising a spring member elastically pushing the tapered surface of said connector plug radially inwardly in the completely inserted state of said connector plug. Claim 4 recites the jack for a connector as claimed in any one of claims 1 to 3, wherein said tip-contact piece comprises a plurality of plate-shaped contact piece portions opposite to each other on both sides of the center axis of said tip electrode, and a plate-shaped jointing portion for jointing proximal ends of said plurality of plate-shaped contact piece portions.

Patent Literature 2

According to the abstract of the Japanese Patent Application Opened No. H10-22,004 (1998), this invention has an object to provide a jack type connector with a microminiaturized jack. Disclosed is a jack type connector comprising a microminiaturized jack having a switch circuit built therein and a body 1 having upper and lower flat surfaces and a plug inserting hole 11 provided with a first movable contact piece member 4 and a second movable contact piece member 5 on both the sides of the plug inserting hole, wherein pulling portions 42 and 52 of the first and second movable contact piece members 4 and 5 are serpentine-shaped to have long lengths and provided with a contact corresponding to a plug side electrode and a contact for the switch circuit.

Incidentally, claim 1 of the Japanese Patent Application Opened No. H10-22,004 (1998) recites a jack type connector comprising a body having upper and lower flat surfaces and an inserting hole for a plug type connector having a tip electrode and an intermediate electrode, said inserting hole being provided on the right and left side of said inserting hole with a first space and a second space, said first space extending along said inserting hole and having a first communication opening communicating with the end of the inserting hole and an opening which opens at the rear surface of said body, and said second space having a second communication opening communicating with said inserting hole, and further comprising a first movable contact piece member and a second movable contact piece member, said first movable contact piece member including a first mounting piece portion arranged on a wall surface of the first space in overlying relationship therewith on the rear portion of said body and a first pulling portion having an elasticity consisting of a forward-facing piece portion extending from the first mounting piece portion and a rearward-facing piece portion extending rearward and provided contiguously to the forward-facing piece portion through a curved rearward-facing turning portion, said first movable contact piece member being formed at a tip end of said rearward-facing piece portion with a first contact which extends from said first communication opening to the end of said inserting hole to contact the tip electrode of said plug type connector, said first movable contact piece member being arranged in said first space, and said second movable contact piece member including a second mounting piece portion arranged on the outer surface of one side wall of said body in overlying relationship therewith, and a second pulling portion having an elasticity consisting of a downwardly extending piece portion provided contiguously to the second mounting piece portion through a curved downwardly turning portion and an upwardly extending piece portion provided contiguously to the downwardly extending piece portion through a curved upwardly turning portion, the second movable contact piece member being formed on the upwardly extending piece portion with a second contact which extends from said second communication opening to the intermediate portion of said inserting hole to contact the intermediate electrode of said plug type connector, said second pulling portion of said second movable contact piece member being received in said second space, and said second mounting piece portion, said downwardly turning portion and said downwardly extending piece portion of said second movable contact piece member being arranged on said body to straddle its one side wall of said body and a clearance being formed between the downwardly turning portion and the upper end portion of said one side wall for accommodating flexing deformation of the second pulling portion in the right and left directions, while the downwardly turning portion being received in a stepped recess formed between the upper surface of said body and the upper end portion of said one side wall. Claim 2 recites the jack type connector as claimed in claim 1, wherein said first mounting piece portion of said first movable contact piece member is formed with a stopper piece by cutting part of the first mounting piece portion and raising the cut part away from the piece portion, the stopper piece serving to regulate a displacement of the rearward-facing piece portion when said first contact comes into contact with the tip electrode of said plug type connector to cause said rearward-facing piece portion to be displaced. Claim 3 recites the jack type connector as claimed in claim 1 or 2, wherein said rearward-facing piece portion is provided with a first movable contact, and a partition wall is provided on said body for bounding said inserting hole and said first space, and wherein said partition wall is provided at its rear end with a first stationary contact, and said first movable contact comes into contact and out of contact with said first stationary contact depending on displacement of said rearward-facing piece portion in the right and left-directions. Claim 4 recites the jack type connector as claimed in claim 1 or 2, wherein said upwardly extending piece portion is provided with a second movable contact, and the wall face of said inserting hole in said second space is provided with a second stationary contact, and wherein said second movable contact comes into contact and out of contact with said second stationary contact depending on displacement of said upwardly extending piece portion in the right and left directions. Claim 5 recites the jack type connector as claimed in claim 1 or 2, wherein said rearward-facing piece portion is provided with a first movable contact, and a partition wall is provided on said body for bounding said inserting hole and said first space, wherein said partition wall is provided at its rear end with a first stationary contact, and said first movable contact comes into contact and out of contact with said first stationary contact depending on displacement of said rearward-facing piece portion in the right and left-directions, wherein said upwardly extending piece portion is provided with a second movable contact, and the wall face of said inserting hole in said second space is provided with a second stationary contact, and wherein said second movable contact comes into contact and out of contact with said second stationary contact depending on displacement of said upwardly extending piece portion in the right and left directions. Claim 6 recites the jack type connector as claimed in claim 3 or 5, wherein there is provided a first stationary contact piece member in the form of a gate including a mounting piece portion arranged on the outer side surface of the other side wall of said body in overlying relationship therewith, a contact piece portion fixed to said partition wall so as to be opposite to the mounting piece portion, and an upper piece portion straddling between upper end portions of these mounting piece portion and contact piece portion, said first stationary contact piece member being arranged on said body in a manner straddling said first space, said upper piece portion being received in a recess formed in the upper surface of said body, and said contact piece portion being formed with said first stationary contact. Claim 7 recites the jack type connector as claimed in any one of claims 4 to 6, wherein there is provided a second stationary contact piece member including a mounting piece portion arranged on the outer side face of the one side wall of said body in overlying relationship therewith rearward of the mounting location of said second mounting piece portion relative to the outer side face of the one side wall of said body, and a contact piece portion extending forwardly from the mounting piece portion and having its front end portion arranged on the wall surface of said inserting hole in said second space, the intermediate portion of said contact piece portion in said second stationary contact piece member being received in a groove formed in the upper surface of said body, and the contact piece portion being formed with said second stationary contact. Claim 8 recites the jack type connector as claimed in any one of claims 1 to 7, wherein said body having the upper and lower flat surfaces and the inserting hole for the plug connector having the tip electrode and two intermediate electrodes arranged side by side in the axial direction, said body having said first space, said second space, and a third space positioned forwardly of said second space side by side and having a third communication opening communicating with said inserting hole, said first, second and third spaces being provided separately on the right and left sides of said inserting hole, said second movable contact piece member being provided with said second contact adapted to contact the one intermediate electrode of said plug connector 1, a third movable contact piece member being provided which comprises a third mounting piece portion arranged on the outer side surface of one side wall of said body in overlying relationship therewith forwardly of the mounting location of said second mounting piece portion relative to the outer side face of one side wall of said body, and a third pulling portion having a downwardly extending piece portion provided contiguously to the third mounting piece portion through a curved downwardly turning portion and an upwardly extending piece portion provided contiguously to the downwardly extending piece portion through a curved upwardly turning portion, said upwardly extending piece portion being formed with a third contact which is caused to extend from said third communication opening to the starting portion of said inserting hole so that the third contact is brought into contact with the other intermediate electrode of said plug connector, said second pulling portion of said third movable contact piece member being received in said third space, said third mounting piece portion, said downwardly turning portion and said downwardly extending piece portion provided on the third movable contact piece member being arranged on the body in a manner straddling its side wall, and a clearance being formed between the downwardly turning portion and the upper end portion of said one side wall for accommodating flexing deformation of the second pulling portion in the right and left directions, while the downwardly turning portion being received in a stepped recess formed between the upper surface of said body and the upper end portion of said one side wall. Claim 9 recites the jack type connector as claimed in any one of claims 1 to 8, wherein said body is formed in its lower surface with a slit so as to expose the lower portion of said inserting hole, and said body is further formed with a boss which is integral with the body so as to straddle the slit and extend downwardly from the lower surface of the body.

Shapes of plug connectors are decided under relevant standards, and such plug connectors are generally equipped with a switch mechanism for confirming whether a plug connector has been inserted. On the other hand, there have been requirements for holding forces of more than 7.84N (0.8 kg) for plug connectors. Under such circumstances, there has been a risk of a plug connector being scratched or damaged when the holding force is intended to increase by the spring members of the switch mechanisms such as the prior art or as disclosed in the Patent Literatures 1 and 2.

Further, the holding force could not be increased sufficiently by the use of the spring members of the switch mechanisms of the prior art and the Patent Literatures 1 and 2.

### SUMMARY OF THE INVENTION

In view of the problems with the prior art, the invention has been completed, and the invention has an object to provide a connector for a jack, which achieves an improved holding force without scratching or damaging a plug connector.

The object of the invention can be achieved by the connector 10 for a jack into which a plug connector 80 in the form of a bar is inserted, including four contacts of first, second, third and fourth contacts 14, 16, 18 and 20 each having a contact portion 34 adapted to contact said plug connector 80 or the other contact and a connection portion 36 to be connected to a substrate, and a housing 12 arranging and holding said four contacts 14, 16, 18 and 20 and having a fitting hole 46 into which said plug connector 80 is inserted to exchange signals through said first and second contacts 14 and 16 being in contact with said plug connector 80 and to ascertain whether said plug connector 80 has been inserted into said connector 10 depending on whether said third and fourth contacts 18 and 20 are in contact with or out of contact with each other, constructed according to the invention in that said third contact 18 is substantially U-shaped in cross-section and comprises a contact piece 28 having a first contact part 40 adapted to contact the mating connector 80, and a spring piece 30 having an elasticity facing to said contact piece 28 and provided by forming a U-shaped slit 32 in a part of said third contact 18 at a location opposite to said contact piece 28, and in that when said plug connector 80 is inserted into said connector 10, said plug connector 80 pushes the first contact part 40 of said contact piece 28 of said third contact 18 to cause said contact piece 28 to be displaced to said spring piece 30 so that said contact piece 28 pushes said spring piece 30 to cause said spring piece 30 to be displaced toward said housing 12 and at the same time said spring piece 30 pushes said contact piece 28 with each other with the aid of the elasticity of said spring piece 30.

The invention claimed in claim 2 lies in the connector 10 for a jack as constructed in that said housing 12 is provided in said fitting hole 46 with an anchoring portion 42 located on the side of a tip of said inserted plug connector 80 and opposite from said contact piece 28 of said third contact 18 so that said anchoring portion 42 engages the tip protrusion 84 of said inserted plug connector 80, and said contact piece 28 of said third contact 18 contacts said plug connector 80, thereby ensuring a reliable holding force for said plug connector 80.

The invention claimed in claim 3 lies in the connector 10 for a jack as constructed in that said housing 12 is formed with a recess 44 in the proximity of said spring piece 30 of said third contact 18 on the side of the tip of said inserted plug connector 80 to enable the elasticity of said spring piece 30 to be maintained even when said contact piece 28 comes into contact with said spring piece 30.

Moreover, the invention claimed in claim 4 lies in the connector 10 for a jack as constructed in that a fifth contact 22 is arranged in the housing 12 on opposite side of said first and second contacts 14 and 16 such that a contact portion 34 of said fifth contact 22 extends into said fitting hole 46.

As can be seen from the above description, the connector for a jack according to the invention can bring about the following significant functions and effects.

(1) A connector for a jack claimed in claim 1 is the connector 10 fora jack, into which a plug connector 80 in the form of a bar is inserted, including four contacts of first, second, third and fourth contacts 14, 16, 18 and 20 each having a contact portion 34 adapted to contact said plug connector 80 or the other contact and a connection portion 36 to be connected to a substrate, and a housing 12 arranging and holding said four contacts 14, 16, 18 and 20 and having a fitting hole 46 into which said plug connector 80 is inserted to exchange signals through said first and second contacts 14 and 16 being in contact with said plug connector 80 and to ascertain whether said plug connector 80 has been inserted into said connector 10 depending on whether said third and fourth contacts 18 and 20 are in contact with or out of contact with each other, wherein said third contact 18 is substantially U-shaped in cross-section and comprises a contact piece 28 having a first contact part 40 adapted to contact the mating connector 80, and a spring piece 30 having an elasticity facing to said contact piece 28 and provided by forming a U-shaped slit 32 in a part of said third contact 18 at a location opposite to said contact piece 28, and wherein when said plug connector 80 is inserted into said connector 10, said plug connector 80 pushes the first contact part 40 of said contact piece 28 of said third contact 18 to cause said contact piece 28 to be displaced to said spring piece 30 so that said contact piece 28 pushes said spring piece 30 to cause said spring piece 30 to be displaced toward said housing 12 and at the same time said spring piece 30 pushes said contact piece 28 with each other with the aid of the elasticity of said spring piece 30. Therefore, the connector according to the invention ensures a stable holding force for the plug connector 80. Even with the increased holding force, the plug connector 80 is never scratched or damaged.

(2) According to the connector 10 for a jack claimed in claim 1, said housing 12 is provided in said fitting hole 46 with an anchoring portion 42 located on the side of a tip of said inserted plug connector 80 and opposite from said contact piece 28 of said third contact 18 so that said anchoring portion 42 engages a tip protrusion 84 of said inserted plug connector 80, and said contact piece 28 of said third contact 18 contacts said plug connector 80, thereby ensuring a reliable holding force for said plug connector 80. Consequently, the holding force for a plug connector 80 can be increased to ensure a stable holding force for the plug connector 80. Even with the increased holding force, the plug connector 80 is never scratched or damaged.

(3) According to the connector 10 for a jack claimed in claim 3, said housing 12 is formed with a recess 44 in the proximity of said spring piece 30 of said third contact 18 on the side of the tip of said inserted plug connector 80 to enable the elasticity of said spring piece 30 to be maintained even when said contact piece 28 comes into contact with said spring piece 30. Accordingly, the holding force for a plug connector 80 can be increased to ensure a stable holding force for the plug connector 80. Even with the increased holding force, the plug connector 80 is never scratched or damaged.

(4) According to the connector 10 for a jack claimed in claim 4, a fifth contact 22 is arranged in the housing 12 on opposite side of said first and second contacts 14 and 16 such that a contact portion 34 of said fifth contact 22 extends into said fitting hole 46. Therefore, the holding force for a plug connector 80 can be increased to ensure a stable holding force for the plug connector 80. Even with the increased holding force, the plug connector 80 is never scratched or damaged.

The invention will be more fully understood by referring to the following detailed specification and claims taken in connection with the appended drawings.

### BRIEF DESCRIPTION OF THE DRAWINGS

FIG. 1A is a perspective view of a connector for a jack according to the invention viewed from the above on the side of its fitting opening;

FIG. 1B is a perspective view of the connector shown in FIG. 1A viewed from the below on the side of the connection portion opposite from the fitting opening;

FIG. 2A is a perspective view of the connector shown in FIG. 1A viewed from the below on the side of the fitting opening;

FIG. 2B is a perspective view of the connector shown in FIG. 1A viewed from the above on the side of the connection portion opposite from the fitting opening;

FIG. 3A is a perspective view of a housing viewed from the above on the side of the connection portion opposite from the fitting opening;

FIG. 3B is a perspective view of the housing viewed from the below on the side of the connection portion opposite from the fitting opening;

FIG. 4 is a perspective view of a first and a second contact;

FIG. 5A is a perspective view of a third contact;

FIG. 5B is a perspective view of a fourth contact;

FIG. 6 is a perspective view of a fifth contact;

FIG. 7A is a perspective view of the third and fourth contacts in contact with each other viewed from the side of a contact piece;

FIG. 7B is a perspective view of the third and fourth contacts in contact with each other viewed from the side of a spring piece;

FIG. 8A is a sectional view of the connector for the jack according to the invention before a plug connector is inserted;

FIG. 8B is a sectional view of the connector for the jack with the plug connector inserted;

FIG. 9 is a perspective view of a plug connector;

FIG. 10A is a sectional view of a connector for a jack of the prior art before the plug connector is inserted;

FIG. 10B is a sectional view of the connector of the prior art with the plug connector inserted;

FIG. 11A is a perspective view of third and fourth contacts in contact with each other used in the prior art connector viewed from the side of a contact piece of the third contact; and

FIG. 11B is a perspective view of the third and fourth contacts in contact with each other viewed from the opposite side of the contact piece of the third contact.

### DESCRIPTION OF THE PREFERRED EMBODIMENTS

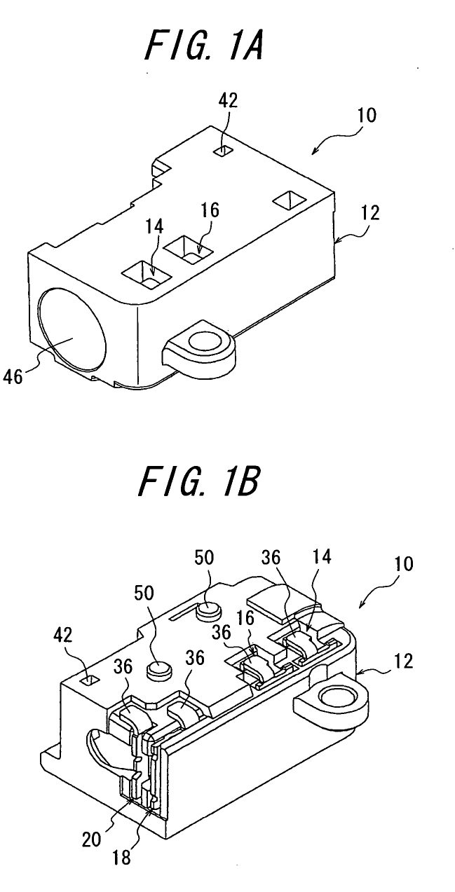

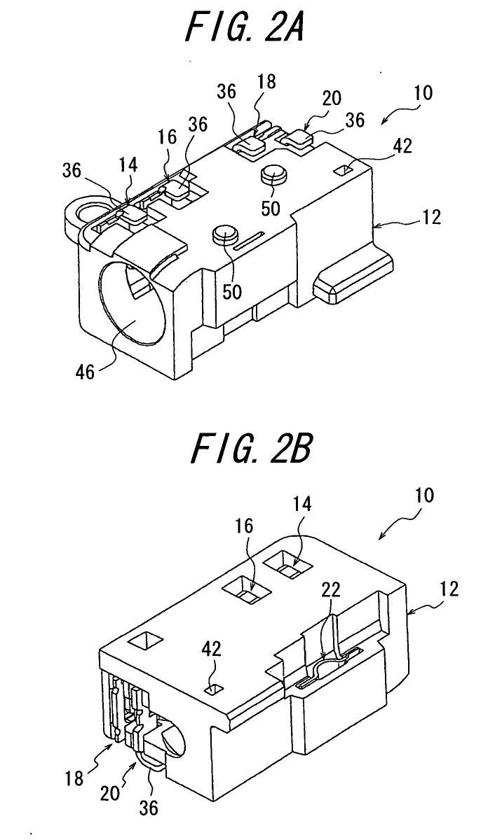

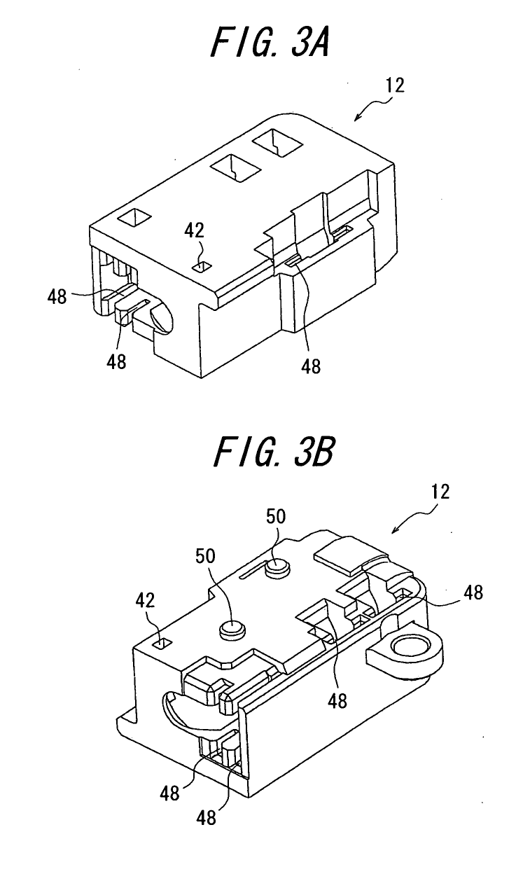

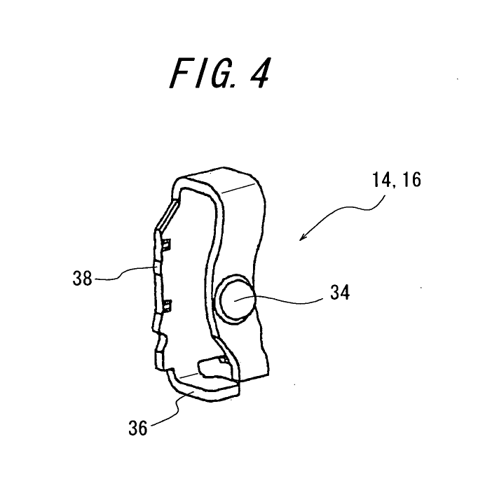

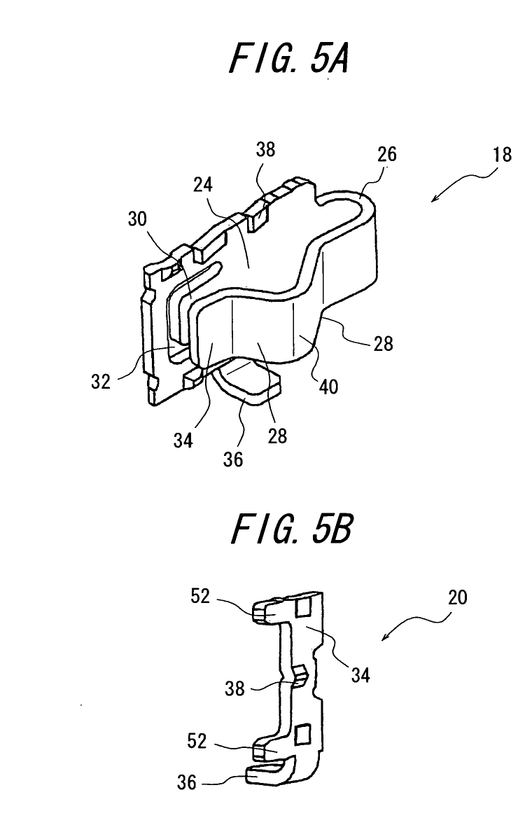

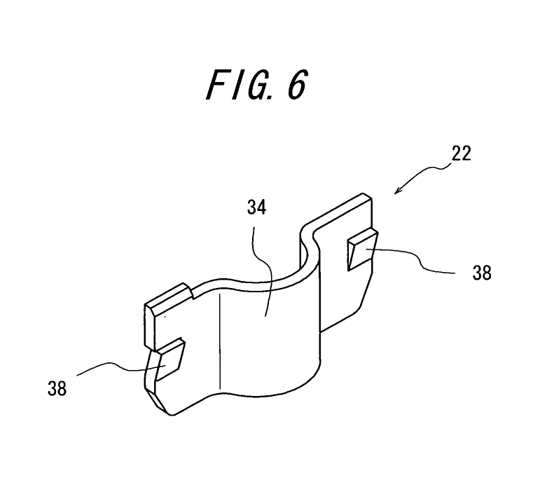

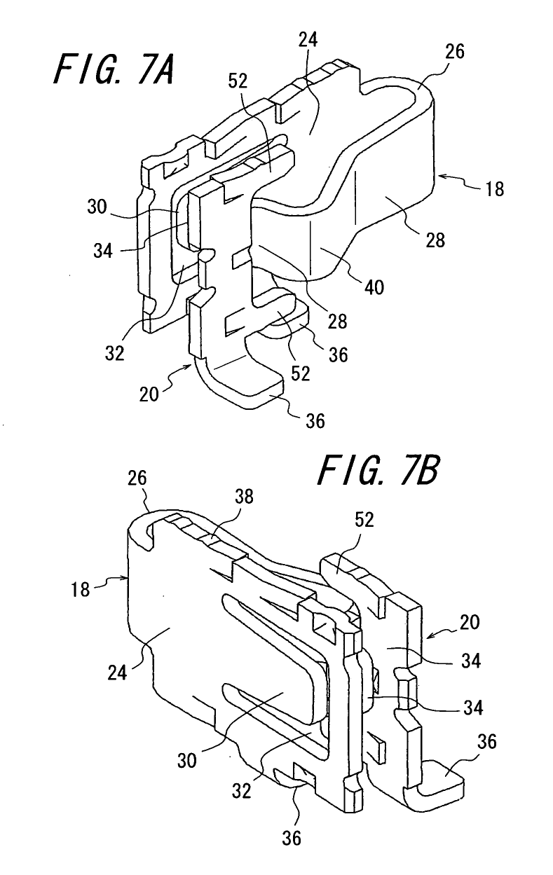

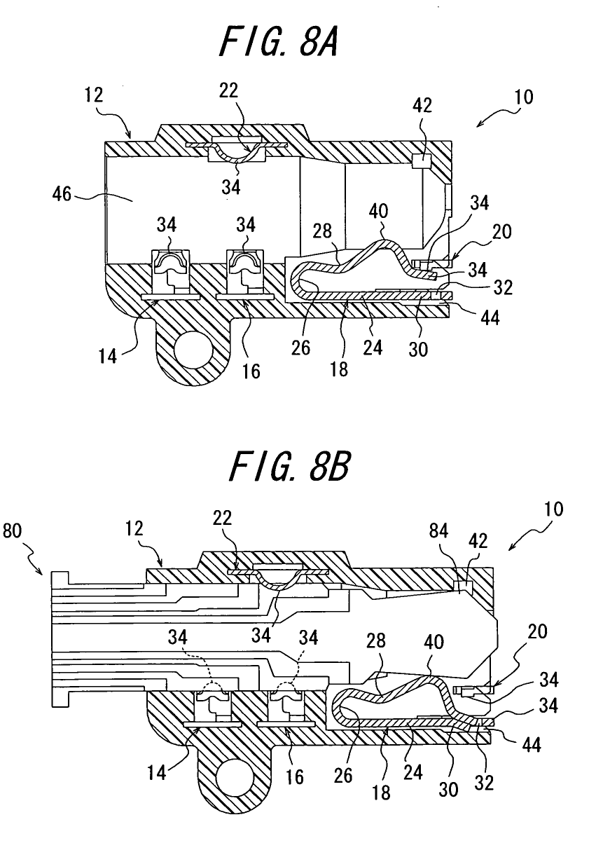

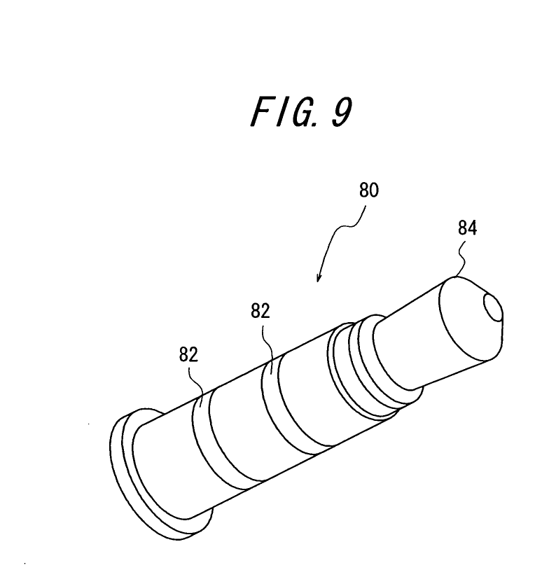

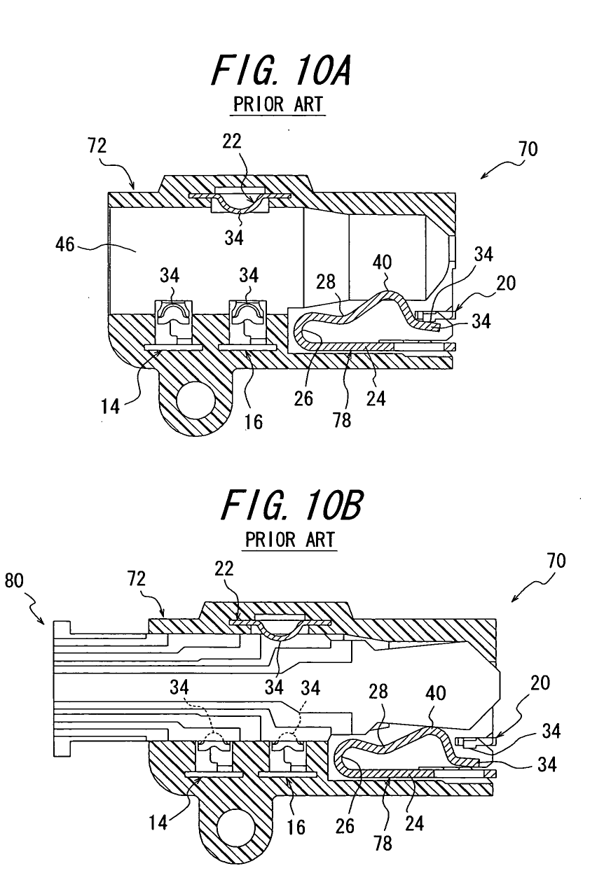

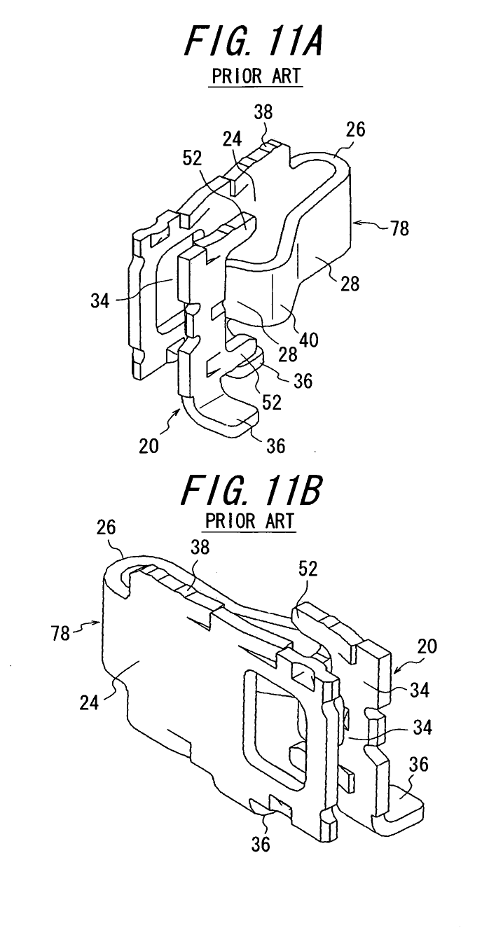

One embodiment of the connector for a jack according to the invention will be explained with reference to FIGS. 1A to 9. FIG. 1A is a perspective view of the connector for a jack according to the invention viewed from the above on the side of its fitting opening, and FIG. 1B is a perspective view of the connector shown in FIG. 1A viewed from the below on the side of the connection portion opposite from the fitting opening. FIG. 2A is a perspective view of the connector for a jack viewed from the below on the side of the fitting opening, while FIG. 2B is a perspective view of the connector viewed from the above on the side of the connection portion opposite from the fitting opening. FIG. 3A is a perspective view of a housing viewed from the above on the side of the connection portion opposite from the fitting opening, and FIG. 3B is a perspective view of the housing viewed from the below on the side of the connection portion opposite from the fitting opening. FIG. 4 is a perspective of a first contact and a second contact. FIG. 5A is a perspective view of a third contact, while FIG. 5B is a perspective view of a fourth contact. FIG. 6 is a perspective view of a fifth contact. FIG. 7A is a perspective view of the third and fourth contacts in contact with each other viewed from the side of a contact piece, and FIG. 7B is a perspective view of the third and fourth contacts in contact with each other viewed from the side of a spring piece. FIG. 8A is a sectional view of the connector for a jack according to the invention before a plug connector is inserted, while FIG. 8B is a sectional view of the connector with the plug connector inserted. FIG. 9 is a perspective view of the plug connector.

The connector 10 for a jack according to the one embodiment of the invention comprises a housing 12, and five contacts (first to fifth contacts) 14, 16, 18, 20 and 22. These components will be explained hereinafter.

Before explaining these components, a plug connector 80 will be explained with reference to FIG. 9. The plug connector 80 is substantially bar-shaped as shown in FIG. 9 and includes second contact elements 82 provided at locations corresponding to the first and second contacts 14 and 16 so as to be in contact with the first and second contacts 14 and 16, respectively for exchanging signals, when the plug connector 80 has been inserted into the connector 10.

The subject feature of the invention lies in the connector 10 for a jack mating with a plug connector 80, which has a switch structure properly operating in any way not damaging the plug connector 80, while keeping a stable holding force for the plug connector 80. In other words, a third contact 18 comprises a contact piece 28 having a first contact part 40 adapted to contact the mating connector 80, and a spring piece 30 having an elasticity facing to the contact piece 28 and obtained by forming a U-shaped slit 32 in a part of said third contact at a location opposite to the contact piece 28, and when the plug connector 80 is inserted into the connector 10, the plug connector 80 pushes the first contact part 40 of the contact piece 28 to cause the contact piece 28 to be displaced to the spring piece 30 so that the contact piece 28 pushes the spring piece 30 to cause the spring piece 30 to be displaced toward the housing 12 and at the same time the spring piece 30 pushes the contact piece 28 with each other with the aid of the elasticity of the spring piece 30. Further, the housing 12 is provided in the fitting hole 46 with an anchoring portion 42 located on the side of a tip of the inserted plug connector 80 and opposite from the contact piece 28 of the third contact 18 so that the anchoring portion 42 engages the tip protrusion 84 of the plug connector 80, and the contact piece 28 contacts the plug connector 80, thereby ensuring a reliable holding force for the plug connector 80.

First, the five contacts (first to fifth contacts) 14, 16, 18, 20 and 22 will be explained. The contacts 14 to 22 are made of a metal and formed by means of the press-working of the known technique. Preferred metals from which to form these contacts 14 to 22 include brass, beryllium copper, phosphor bronze and the like which comply with the requirements as to springiness, electric conductivity, and the like. These contacts (first to fifth contacts) 14 to 22 each comprise at least a contact portion 34 adapted to contact said plug connector 80 or a mating object (the other contact), and a fixed portion 38 to be held in the housing 12.

First, the third contact 18 will be explained with reference to FIG. 5A. The third contact 18 is substantially U-shaped in cross-section and comprises a body portion 24 on one end, a contact piece 28 on the other end having a contact portion 34 adapted to contact said fourth contact 30 and a first contact part 40 adapted to contact said plug connector 80, and a jointing portion 26 for jointing said contact piece 28 and said body portion 24. The body portion 24 is formed with a U-shaped slit 32 at location opposite to the contact piece 28 having the fist contact part 40 adapted to contact the plug connector 80, thereby providing a spring piece 30 having an elasticity opposite to said contact piece 28. The body portion 24 is further formed with fixed portions 38 on both sides in the width direction (vertical direction viewed in FIG. 5A) for fixing the third contact 18 to the housing 12, and with a connection portion 36 on one side in the width direction to be connected to a substrate.

The shape and size of the first contact part 40 of said contact piece 28 may be any ones insofar as the fist contact part 40 comes into contact with and is pushed by said plug connector 80 when it is inserted into the connector 10, and comes out of contact with the fourth contact 20 upon being pushed by the plug connector 80. The shape and size of the first contact part 40 may be suitably designed in consideration of these functions and the elasticity, workability, strength, and the like of the contact piece 28.

As described above, the body portion 24 of the third contact 18 is formed with the U-shaped slit 32 at a location opposite to said contact piece 28 having said first contact part 40 to provide a spring piece 30 having the elasticity in the position opposite to the contact piece 28. When the plug connector 80 is inserted into the connector 10, the plug connector 80 pushes the first contact part 40 of the contact piece 28 so that the contact piece 28 is displaced to the spring piece 30 so as to push the spring piece 30, thereby causing the spring piece 30 to move toward the housing 12. In this way, said spring piece 30 is displaced toward the housing, while pushing the contact piece 28 because of the elasticity of the spring piece 30, thereby obtaining a stable contact (pushing) between the first contact part 40 and the plug connector 80. The shapes and sizes of said slit 32 and said spring piece 30 may be suitably designed taking into account such functions, elasticity, workability, strength, and the like of the third contact 18.

The shape and size of said body portion 24 may be suitably designed so as to enable said slit 32 and said spring piece 30 to be arranged in consideration of the functions of the slit 32 and the spring piece 30 described above, and the miniaturization, strength, workability, and the like. Moreover, the jointing portion 26 serves to joint said body portion 24 and said contact piece 28, but is designed so as not to reduce the elasticity of the contact piece 28.

The shape and size of said contact portion 34 may be any ones so long as the contact portion 34 is in contact with the fourth contact 20 in the state that said plug connector 80 has not been inserted into the connector 10. The contact portion 34 is substantially plate-shaped in the illustrated embodiment.

The shape and size of the connection portion 36 of said third contact 18 may be suitably designed in consideration of its occupied area on the substrate, a shape of the patterns on the substrate, degree of high-density, workability, and the like. In the illustrated embodiment, the connection portion 36 is of a surface mounting type (SMT), but it may be a dip type. The shape and size of said fixed portion 38 may be suitably designed taking into account the holding force, miniaturization, workability, and the like. The fixed portion 38 is fixed to the housing 12 by press-fitting, hooking (lancing), or welding. In the illustrated embodiment, the fixed portion 38 is fixed to the housing 12 by the press-fitting.

The fourth contact 20 will then be explained. The fourth contact 20 is substantially L-shaped as shown in FIG. 5B and comprises a contact portion 34 at one end adapted to contact said third contact 18, a connection portion 36 at the other end to be connected to the substrate, and a fixed portion 38 between said contact portion 34 and said connection portion 36 to be fixed to said housing 12. The shape and size of said contact portion 34 may be any ones insofar as the contact portion 34 can contact the third contact 18 in the state that the plug connector 80 has not been inserted into the connector 10. The contact portion 34 is substantially plate-shaped in the illustrated embodiment.

The shape and size of the connection portion 36 of said fourth contact 20 may be suitably designed taking into account its occupied area on the substrate, a shape of the patterns on the substrate, degree of high-density, workability, and the like. The connection portion 36 is of a surface mounting type (SMT), but it may be a dip type. The shape and size of said fixed portion 38 may be suitably designed in consideration of the holding force, miniaturization, workability, and the like. The fixed portion 38 is fixed to the housing 12 by press-fitting, hooking (lancing), or welding. The fixed portion 38 is fixed to the housing 12 by the press-fitting in the illustrated embodiment.

Moreover, the fourth contact 20 is provided with two extending pieces 52 at its one end and the other end for preventing the third contact 18 from wobbling or tilting. The shape and size of said extending pieces 52 may be any ones so long as they can prevent the wobbling of the third contact 18, and may be suitably designed in consideration of their function, miniaturization, workability, strength, and the like.

The first contact 14 and the second contact 16 will then be explained. The first and second contacts 14 and 16 are substantially U-shaped as shown in FIG. 4 and each comprise at least a contact portion 34 adapted to contact the plug connector 80, a fixed portion 38 to be fixed to said housing 12, and a connection portion 36 to be connected to the substrate. The shape and size (including a distance to which the contact portion extends) of said contact portion 34 may be any ones so long as it can contact the plug connector 80 and may be suitably designed taking into account the contact stability, elasticity, miniaturization, workability, an the like. In the illustrated embodiment, the contact portion 34 is curved or smoothly bent.

The shape and size of the connection portions 36 of said first and second contacts 14 and 16 may be suitably designed in consideration of their occupied areas on the substrate, a shape of the patterns on the substrate, degree of high-density, workability, and the like. Although the connection portions are of a surface mounting type (SMT) in the illustrated embodiment, they may be of a dip type. The shape and size of said fixed portions 38 may be suitably designed taking into account the holding force, miniaturization, workability, and the like. The fixed portions 38 are fixed to the housing 12 by press-fitting, hooking (lancing), or welding. In the illustrated embodiment, the fixed portions 38 are fixed to the housing 12 by the press-fitting.

The fifth contact 22 will then be explained. The fifth contact 22 is substantially Ω-shaped in cross-section as shown in FIG. 6 and comprises at least a contact portion 34 adapted to contact said plug connector 80, and fixed portions 38 to be fixed to said housing 12. The fifth contact 22 pushes the plug connector 80 toward said first and second contacts 14 and 16, thereby obtaining stable contact between the first and second contacts 14 and 16 respectively and said plug connector 80. For this purpose, the fifth contact 22 is mounted in the housing so that the contact portion 34 extends into a fitting hole 46 of said housing 12. The distance to which the contact portion 34 extends into the fitting hole 46 is suitably designed so as to achieve such a function.

The location where said fifth contact 22 is arranged may be suitably designed to achieve such a function. In consideration of such a function, it is preferable to arrange the fifth contact 22 at a position opposite to the first contact 14 or the second contact 16. The contact portion 34 of said fifth contact 22 is bent substantially in the form of a semicircle taking into account the above function. The fifth contact 22 is fixed to said housing 12 by press-fitting.

Finally, said housing 12 will be explained with reference to FIGS. 3A and 3B. The housing 12 is formed from an electrically insulating plastic material by means of the injection molding of the known technique. The materials for the housing 12 may be suitably selected in consideration of dimensional stability, workability, manufacturing cost, and the like and generally include polybutylene terephthalate (PBT), polyamide (66PA or 46PA), liquid crystal polymer (LCP), polycarbonate (PC), and the like and combination thereof.

Said housing 12 is formed with a fitting hole 46 (FIGS. 1A and 2A) for inserting said plug connector 80. The size and shape of said fitting hole 46 may be suitably designed in consideration of the shape and size of said plug connector 80 and connectivity between said first, second and third contacts 14, 16 and 18 respectively and said plug connector 80. Moreover, said housing 12 is provided with contact-mounting portions 48 for inserting and holding the contact 14, 16, 18, 20 and 22, respectively.

The contact-mounting portions 48 for the first and second contacts 14 and 16 are at locations corresponding to the second contact elements 82 of said plug connector 80 and enabling the contact portions 34 of the first and second contacts 14 and 16 to contact said second contact elements 82. Said third and fourth contacts 18 and 20 serve to detect whether said plug connector 80 has been inserted into the connector 10. Therefore, the contact-mounting portions 48 of said third and fourth contacts 18 and 20 are arranged at locations on the side of the housing opposite from the opening of the fitting hole 46 for the plug connector 80, but on the same side as the contact-mounting portions 48 of said first and second contacts 14 and 16 with respect to the center axis of the fitting hole 46 for the plug connector 80 in a manner that the third contact 18 and the fourth contact 20 are in contact with each other, and the third contact 18 comes into contact with said plug connector 80 when it is inserted into the connector 10. The contact-mounting portion 48 of said fifth contact 22 is arranged on the side of the housing 12 opposite from the contact-mounting portions 48 of said first and second contacts 14 and 16 such that the contact portion 34 of said fifth contact 22 enables said inserted plug connector 80 to push to said first and second contacts 14 and 16. The shapes and sizes of the contact-mounting portions 48 of the respective contacts 14 to 22 may be suitably designed in consideration of the shapes, sizes, holding forces, miniaturization, workability, strength, and the like.

Said housing 12 is further provided with an anchoring portion 42 (FIGS. 8A and 8B) which is located contiguously with the fitting hole 46 on the side of the housing opposite from the opening of the fitting hole 46 and adapted to engage the tip protrusion 84 of said plug connector 80. The anchoring portion 42 engages said tip protrusion 84 of the plug connector 80 to enhance the holding force for the plug connector 80. The shape and size of the anchoring portion 42 may be any ones so long as the anchoring portion 42 is able to engage the plug connector 80 to achieve such a function. It may be a through-hole, or a recess (groove), but the through-hole is preferable in consideration of the workability.

Moreover, the housing is provided with bosses 50 on the side of the housing to be connected to the substrate for positioning the housing relatively to the substrate as shown in FIGS. 1B, 2A and 3B. The shape, size and positions of said bosses may be suitably designed taking into account the ease in positioning, miniaturization, the patterns of the substrate, workability, strength, and the like.

Furthermore, the housing 12 is formed with a recess 44 in the proximity of said spring piece 30 of said third contact 18 on the side of the tip of the inserted plug connector 80 as shown in FIGS. 8A and 8B. The recess 44 provides a space to receive said spring piece 30 to permit its elastic deformation or to maintain its elasticity or resilience when the contact piece 28 of the third contact 18 is brought into contact with the spring piece 30 of the third contact. The shape and size of said recess 44 may be suitably designed in consideration of such a function, miniaturization, strength, and workability.

Examples of applications of the invention are connectors for a jack, which are used in electric and electronic appliances such as audio systems, and more particularly a connector for a jack, which enables a stable holding force for a plug connector as a mating connector without in any way scratching or damaging the plug connector.

While the invention has been particularly shown and described with reference to the preferred embodiments thereof, it will be understood by those skilled in the art that the foregoing and other changes in form and details can be made therein without departing from the spirit and scope of the invention.

1. A connector for a jack, into which a plug connector in the form of a bar is inserted,
including four contacts of first, second, third and fourth contacts each having a contact portion adapted to contact said plug connector or the other contact and a connection portion to be connected to a substrate, and a housing arranging and holding said four contacts and having a fitting hole into which said plug connector is inserted to exchange signals through said first and second contacts being in contact with said plug connector and to ascertain whether said plug connector has been inserted into said connector depending on whether said third and fourth contacts are in contact with or out of contact with each other,
wherein said third contact is substantially U-shaped in cross-section and comprises a contact piece having a first contact part adapted to contact the mating connector, and a spring piece having an elasticity facing to said contact piece and provided by forming a U-shaped slit in a part of said third contact at a location opposite to said contact piece, and
wherein when said plug connector is inserted into said connector, said plug connector pushes the first contact part of said contact piece of said third contact to cause said contact piece to be displaced to said spring piece so that said contact piece pushes said spring piece to cause said spring piece to be displaced toward said housing and at the same time said spring piece pushes said contact piece with each other with the aid of the elasticity of said spring piece.

2. The connector for a jack as claimed in claim 1, wherein said housing is provided in said fitting hole with an anchoring portion located on the side of a tip of said inserted plug connector and opposite from said contact piece of said third contact so that said anchoring portion engages a tip protrusion of said inserted plug connector, and said contact piece of said third contact contacts said plug connector, thereby ensuring a reliable holding force for said plug connector.

3. The connector for a jack as claimed in claim 1, wherein said housing is formed with a recess in the proximity of said spring piece of said third contact on the side of the tip of said inserted plug connector to enable the elasticity of said spring piece to be maintained even when said contact piece comes into contact with said spring piece.

4. The connector for a jack as claimed in claim 1, wherein a fifth contact is arranged in the housing on opposite side of said first and second contacts such that a contact portion of said fifth contact extends into said fitting hole.

5. The connector for a jack as claimed in claim 2, wherein said housing is formed with a recess in the proximity of said spring piece of said third contact on the side of the tip of said inserted plug connector to enable the elasticity of said spring piece to be maintained even when said contact piece comes into contact with said spring piece.

6. The connector for a jack as claimed in claim 2, wherein a fifth contact is arranged in the housing on opposite side of said first and second contacts such that a contact portion of said fifth contact extends into said fitting hole.

7. The connector for a jack as claimed in claim 3, wherein a fifth contact is arranged in the housing on opposite side of said first and second contacts such that a contact portion of said fifth contact extends into said fitting hole.
